(19) United States
(12) Patent Application Publication
(10) Pub. No.: US 2025/0163825 A1
(43) Pub. Date: May 22, 2025

(54) VARIABLE INLET GUIDE VANES FOR A TURBOMACHINE, TURBOMACHINE INCLUDING SAME AND METHOD

(71) Applicant: NUOVO PIGNONE TECNOLOGIE - S.R.L., Florence (IT)

(72) Inventors: Manuele BIGI, Firenze (IT); Massimo CAMATTI, Pistoia (IT); Matteo DOZZINI, Firenze (IT); Ernani Fulvio BELLOBUONO, Firenze (IT)

(21) Appl. No.: 18/839,638

(22) PCT Filed: Feb. 20, 2023
(86) PCT No.: PCT/EP2023/025082

§ 371 Date: Aug. 19, 2024

(30) Foreign Application Priority Data
Feb. 25, 2022 (IT) 102022000003599

(51) Int. Cl. F01D 17/16

(52) U.S. Cl. CPC F01D 17/165; F05D 2230/60

(57) ABSTRACT

The variable inlet guide vane device comprises a disc-shaped member and an annular member coaxial to disc-shaped member and forming a unit therewith. A set of variable inlet guide vanes are pivotally mounted between the disc-shaped member and the annular member. Each variable inlet guide vane comprises a first pivoting pin and a second pivoting pin. The first pivoting pin is pivotally supported by a first bearing housed in the disc-shaped member and the second pivoting pin is pivotally supported by a second bearing housed in the annular member.

### TECHNICAL FIELD

The present disclosure relates to the field of turbomachines, such as in particular, but without limitations, centrifugal compressors. Specifically, the present disclosure concerns variable inlet guide vanes for turbomachines, e.g., centrifugal compressors, and methods for mounting and installing said variable inlet guide vanes in the turbomachine.

### BACKGROUND ART

Turbomachines generally include a flow path for a fluid including an inlet, one or more impellers arranged for rotation in a casing, and an outlet. In compressors, such as centrifugal compressors, mechanical power is used to rotate the impellers and compress the fluid, while in expanders a compressed fluid expands and drives the impellers in rotation to produce mechanical power.

Some turbomachines, such as centrifugal compressors, for instance, include variable inlet guide vanes (shortly also referred to as IGV) arranged at the inlet of the first, i.e., most upstream impeller. The geometry of the inlet guide vanes can be controlled and changed to maximize the efficiency of the turbomachine when the operating conditions thereof change, for instance when the rotary speed increases or decreases with respect to a design operating point.

An actuation system or system is provided to simultaneously act upon each inlet guide vane and change the inclination thereof according to needs. The variable inlet guide vanes and relevant actuation system are complex mechanical components, which need to be assembled in the turbomachine casing, usually between an inlet plenum and the inlet side of the first impeller.

It would be beneficial to simplify the variable IGV and relevant actuation system and to make assembling thereof easier and faster.

### SUMMARY

According to an aspect, in order to overcome or alleviate drawbacks of the variable IGV systems of the current art, disclosed herein is a variable inlet guide vane device for a turbomachine, comprising in combination a disc-shaped member and an annular member coaxial to disc-shaped member and forming a unit therewith. A set of variable inlet guide vanes are pivotally mounted between the disc-shaped member and the annular member.

Each variable inlet guide vane comprises a first pivoting pin and a second pivoting pin. Each first pivoting pin is pivotally supported by a first bearing or bushing housed in the disc-shaped member and each second pivoting pin is supported by a second bearing or bushing housed in the annular member. The first and second pivoting pin of each variable inlet guide vane commonly define a pivoting axis, which can be parallel to the axis of the disc-shaped member and annular member.

Each variable inlet guide vane comprises a trailing portion, integral with the pivoting pin and movable around an axis of the pivoting pin with respect to the disc-shaped member and the annular member. At least some of the variable inlet guide vanes include a leading portion, which is stationary with respect to the disc-shaped member and the annular member.

The disc-shaped member, the annular member and the variable inlet guide vanes arranged therebetween can be assembled as a single unit, assembly or device, which can be possibly tested before mounting in the turbomachine. The unit can then be installed in the turbomachine as a sub-assembly, with simple and fast mounting.

The disc-shaped member and the annular member can be fastened to one another by means of screws or other fastening or connection members.

In embodiments disclosed herein, each variable inlet guide vane can be a so-called flapped variable IGV. In such embodiments, each variable IGV can comprise a leading portion which is stationary with respect to the disc-shaped member and the annular member and forms a leading edge of the inlet guide vane. Each variable IGV can further include a trailing portion forming a trailing edge of the inlet guide vane. The trailing portion is integral with the first pivoting pin and second pivoting pin. The trailing portion of each inlet guide vane is rotatably movable around an axis of the first pivoting pin and second pivoting pin with respect to the disc-shaped member and the annular member.

According to a further aspect, disclosed herein is a turbomachine, in particular a centrifugal compressor, comprising a casing and at least one impeller rotatingly supported in the casing. The turbomachine further includes an inlet plenum and a variable IGV device as outlined above, arranged coaxial with the impeller and positioned between the inlet plenum and an inlet of the impeller.

According to a further aspect, disclosed herein is a method for assembling variable inlet guide vanes for a turbomachine, the method comprising the following steps:
mounting a set of first bearings in a disc-shaped member;
mounting a set of second bearings in an annular member;
rigidly connecting the disc-shaped member and the annular member to one another with a plurality of variable inlet guide vanes housed therebetween. Each variable inlet guide vane comprises a first pin supported for rotation in the first bearing and a second pin supported for rotation in the second bearing. Moreover, each variable inlet guide vane comprises a trailing portion, integral with the pivoting pin and movable around an axis of the pivoting pin with respect to the disc-shaped member and the annular member; and at least some of the variable inlet guide vanes include a leading portion, which is stationary with respect to the disc-shaped member and the annular member.

The method can further include a step of testing the variable IGV device or sub-assembly thus formed and finally a step of mounting the variable IGV device in a turbomachine.

### BRIEF DESCRIPTION OF THE DRAWINGS

Reference is now made briefly to the accompanying drawings, in which:

FIG. 1 is a partial cross-sectional view of a centrifugal compressor including variable IGV device according to the present disclosure;

FIG. 1A is an enlargement of a detail of FIG. 1;

FIG. 2 is an axonometric view of the variable IGV device from the side facing the inlet plenum;

FIG. 3 is an axonometric view of the device of FIG. 2 from the side facing the impeller;

FIG. 4 is a sectional view of the variable IGV device according to a plane containing the axis thereof;

FIG. 5 is a sectional view according to V-V of FIG. 4;

FIG. 6 is a sectional view according to VI-VI of FIG. 5; and

FIG. 7 is a flowchart of a method according to the present disclosure.

### DETAILED DESCRIPTION

A novel structure for a variable inlet guide vane arrangement is disclosed herein. To simplify the design, assembling and testing of the variable IGV arrangement, the vanes are pivotally mounted between two coaxial components, thus forming a single unit or assembly including the two coaxial components and the variable inlet guide vanes arranged therebetween. The unit can further include an actuation system for controlling angular displacement of the inlet guide vanes.

The unit including the variable inlet guide vanes, the two coaxial components and the actuation system can be assembled and tested before insertion in a turbomachine as a single sub-assembly thereof. Assembling, testing and mounting in the turbomachine are thus made faster and simpler.

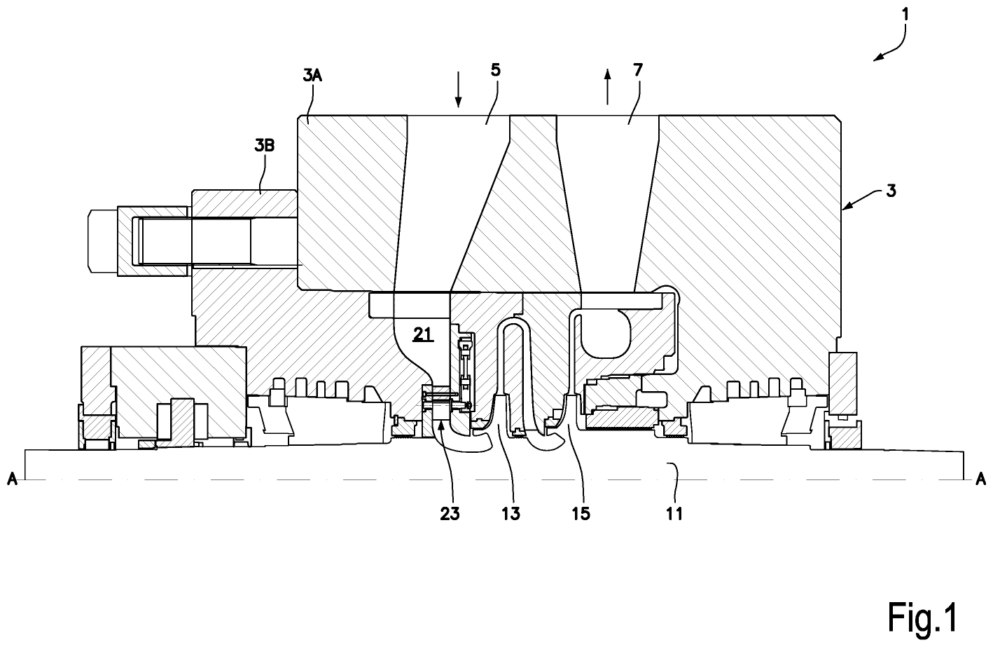

Turning now to the drawings, FIG. 1 and the enlargement of FIG. 1A illustrate a sectional view of a centrifugal compressor including variable inlet guide vanes assembled as a single device according to the present disclosure. The compressor 1 of FIG. 1 is shown as a non-limiting exemplary embodiment of a turbomachine, wherein the novel variable inlet guide vanes of the present disclosure can be used. Those skilled in the art will understand that the compressor may differ substantially from the example shown in FIG. 1. Also, those skilled in the art of turbomachines will understand that the inlet guide vanes disclosed herein can be used also in different kinds of turbomachines, such as expanders or turbines.

The compressor 1 includes a casing 3 with an inlet 5 and an outlet 7. In the exemplary embodiment of FIG. 1 the casing comprises a barrel 3A and a front closure 3B, in a vertically-split arrangement. In other embodiments, the casing can be a horizontally-split casing, with two casing parts coupled along a plane parallel to the rotation axis of the compressor.

A shaft 11 is supported for rotation around an axis A-A in the casing 3. One or more compressor impellers are mounted on the shaft 11 for co-rotation therewith. In other embodiments, the impellers may be configured as stacked impellers with a central tie rod, for instance.

In the exemplary embodiment of FIG. 1, the compressor 1 comprises a first, upstream impeller 13 and a second, downstream impeller 15. A first diaphragm 17 is arranged around the first impeller 13 and a second diaphragm 19 is arranged around the second impeller 19. The number of impellers and their arrangement is shown as a non-limiting example.

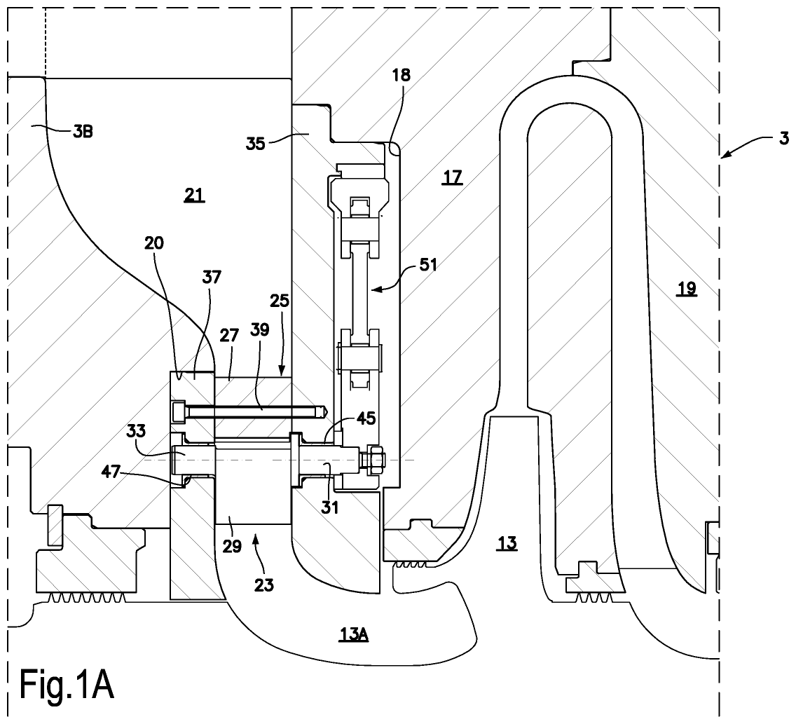

A gas flow path extends from the compressor inlet 5 through an inlet plenum 21, the first impeller 13 and second impeller 15, towards the compressor outlet 7. A variable inlet guide vane device 23 is arranged between the inlet plenum 21 and a suction side or inlet side 13A of the first impeller 13. Details of the device 23 are disclosed here after, with reference to FIGS. 2, 3, 4, 5 and 6.

The variable inlet guide vane device 23 comprises a plurality of inlet guide vanes 25 arranged circumferentially around the axis A-A of the device 23. When mounted in the compressor 1, the axis A-A of the device 23 is coincident with the rotation axis A-A of the shaft 11.

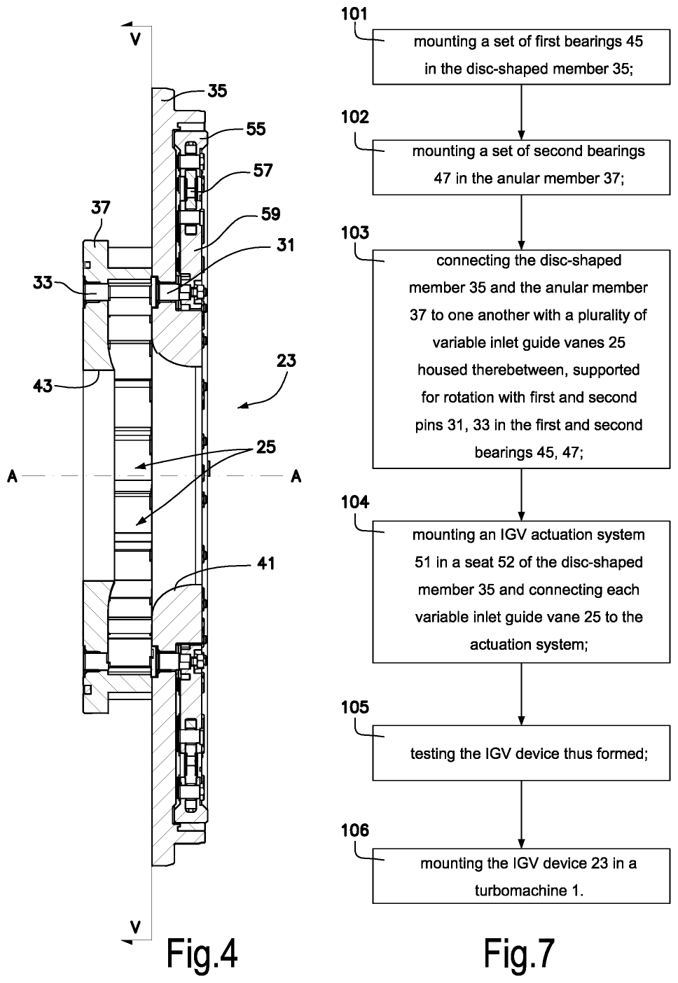

In the illustrated embodiment, each variable inlet guide vane 25 comprises a leading portion 27 and a trailing portion 29 as best shown in FIG. 5. The leading portion 27 features a leading edge 25L of the respective variable inlet guide vane 25 and the trailing portion 29 features a trailing edge 25T of the variable inlet guide vane 25. As best shown in FIG. 5, the shape of the inlet guide vanes 25 may be variable from one vane to the other around the axis A-A. In some embodiments one or some additional variable inlet guide vane 25X, including a trailing portion 29X, but not including a leading portion, may be added to the set of variable inlet guide vanes 25.

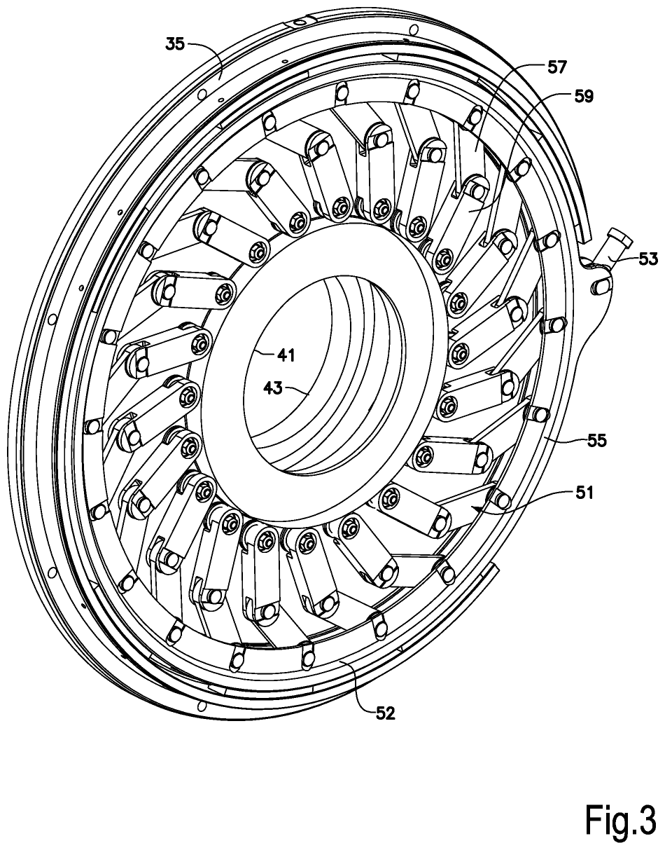

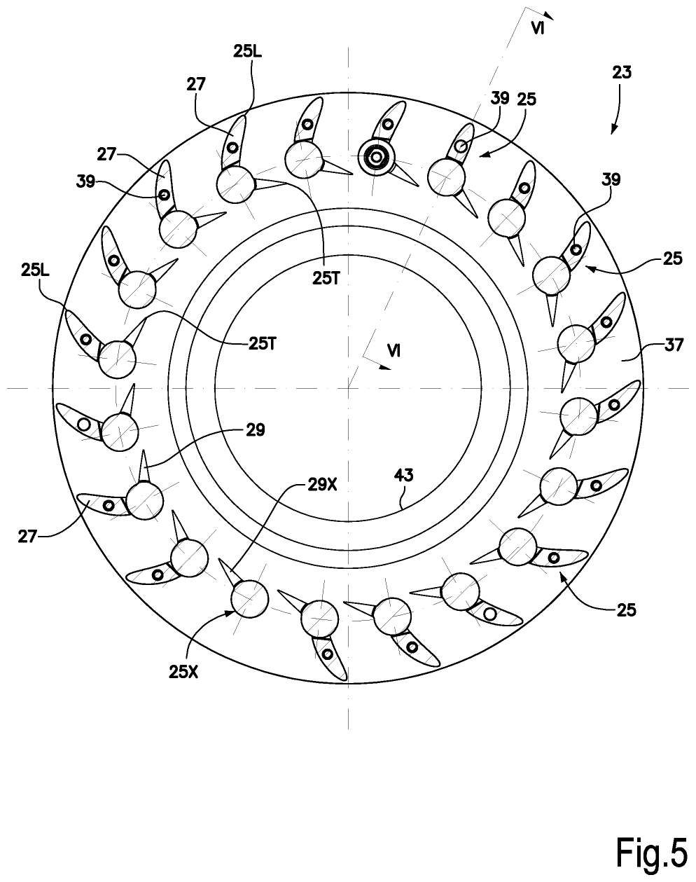

As best shown in FIGS. 4 and 6, each trailing portion 29 of the variable inlet guide vanes 25 includes a first pin 31 and a second pin 33 adapted to pivotally support the respective variable inlet guide vane, and more specifically the trailing potion 29 thereof.

The variable IGV device 23 includes a disc-shaped member 35 and an annular member 37 connected to one another with the inlet guide vanes 25 arranged there-between. The annular member 37 and the disc-shaped member 35 are rigidly connected to one another by connection members 39. In some embodiments, the connection members 39 may be, or may include, screws. The connection members 39 preferably extend through the leading portion 27 of at least some of the variable inlet guide vanes, as best shown in FIGS. 1A, 2 and 5, such that they do not interfere with the gas path extending through the variable IGV device 23.

The disc-shaped member 35 comprises an axial aperture 41 and the annular member 37 comprises an axial aperture 43. The two axial apertures 41, 43 are co-axial and allow the compressor shaft to extend therethrough. Moreover, the axial aperture 41 and the flow passages between the variable inlet guide vanes 25 feature a gas flow passage towards the impeller inlet 13A when the device 23 is mounted in the compressor 1, see FIGS. 1 and 1A.

The disc-shaped member 35 comprises a plurality of first bearings or bushings 45. Each first bearing or bushing 45 houses a respective first pin 31. The annular member 37 comprises a plurality of second bearings or bushings 47. Each second bearing or bushing 47 houses a respective second pins 33. Thus, each trailing portion 29 of the variable inlet guide vanes 25 is supported between the disc-shaped member 35 and the annular member 37 and can rotate around an axis of the respective co-axial first pin 31 and 33.

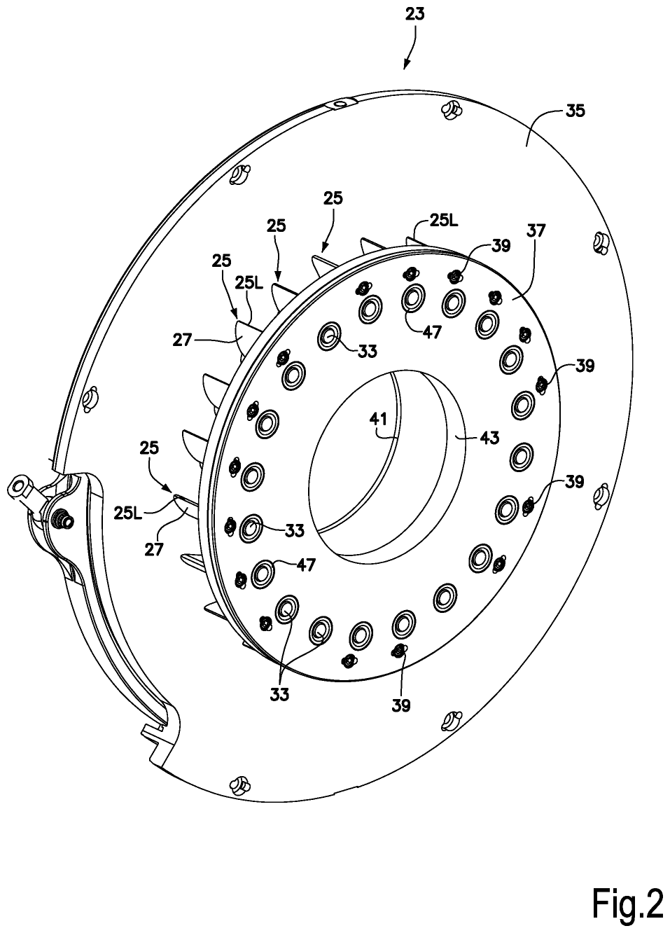

The angular displacement of each trailing portion 39 can be controlled by an actuation system 51, see FIG. 3. The actuation system 51 can be housed in a seat 52 formed in the side of the disc-shaped member 35 facing opposite the annular member 37.

In some embodiments, as best shown in FIG. 3, the actuation system 51 includes a connector 53 for connection to a servo-actuator or the like, not shown. The connector 53 is hinged to a ring 55, coaxial to the disc-shaped member 35 and to the annular member 37. The ring 55 can perform angular displacements around the axis A-A of the device 23. The ring 55 can be drivingly coupled to the first pin 31 of each trailing portion of the variable inlet guide vanes 25 by connection levers 57, 59. The actuation system 51 is thus adapted to control simultaneous rotation of each trailing portion 29 of the variable inlet guide vanes 25.

The bearings or bushings 45, 47, the disc-shaped member 35, the annular member 37 and the actuation system 51 are thus combined in a single unit or sub-assembly that can be assembled separately from the compressor 1. Once assembled, the device 23 can be tested and finally installed in the compressor 1.

The variable IGV device 23 is housed in the compressor 1 in a position such that the inlet guide vanes 25 are located in the annular aperture fluidly coupling the inlet plenum 21 to the suction side 13A of the first impeller 13. In the embodiment of FIG. 1, the disc-shaped member 35 is housed in a seat formed in the stationary diaphragm 17 and more specifically in an annular seat 18 provided in the surface of the diaphragm 17 facing the inlet plenum 21. Once mounted, the annular member 37 of the variable IGV device 23 can be at least partly housed in a seat 20 formed in the front portion of the casing 3, which in the embodiment shown in the drawings is featured by the front closure 3B

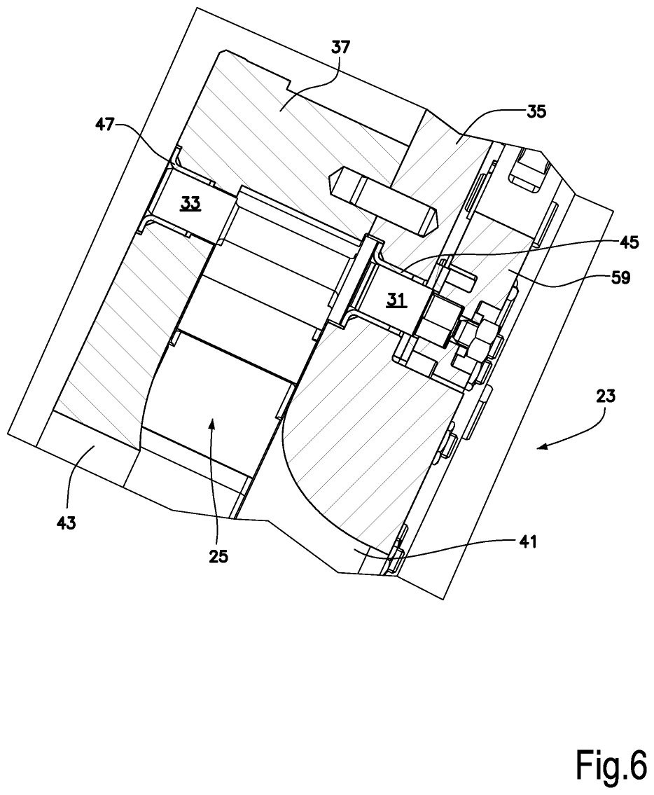

FIG. 7 illustrates a flow chart summarizing a method for assembling and mounting the inlet guide vanes in a compressor.

The method includes a step of mounting the first bearings 45 in the disc-shaped member 35 (step 101) and a step of mounting the second bearings 47 in the annular member 37 (step 102). The steps 101 and 102 can be performed in any sequence or simultaneously. The method further comprises the step of rigidly connecting the disc-shaped member 35 and the annular member 37 to one another (step 103) with the variable inlet guide vanes 25 housed therebetween. Each variable inlet guide vane 25 has the first pin 31 housed for rotation in the respective first bearing 45 and the second pin 33 housed for rotation in the respective second bearing 47. The disc-shaped member 35, the annular member 37 and the variable inlet guide vanes 25 thus form a unit or sub-assembly. The actuation system 51 can be mounted on the back of the disc-shaped member 35 (step 104). The sub-assembly or unit thus assembled can be tested (step 105) and then be introduced and mounted into the compressor 1 (step 106).

The sequence of operations described above can be changed with some of the steps being performed in a reversed sequence. For instance, the actuations system 51 can be mounted once the inlet guide vanes 25 have been mounted on the disc-shaped member 35, with the first pins 31 introduced in the first bushings or bearings 45, and then the annular member 37 can be attached to the disc-shaped member 35 with the second pins 33 being introduced in the second bearings or bushings 47.

Exemplary embodiments have been disclosed above and illustrated in the accompanying drawings. It will be understood by those skilled in the art that various changes, omissions and additions may be made to that which is specifically disclosed herein without departing from the scope of the invention as defined in the following claims.

1. A variable inlet guide vane device for a turbomachine, comprising:
a disc-shaped member;
an annular member coaxial to disc-shaped member and forming a unit therewith; and
a set of variable inlet guide vanes pivotally mounted between the disc-shaped member and the annular member;
wherein each variable inlet guide vane comprises a first pivoting pin and a second pivoting pin; wherein each first pivoting pin is pivotally supported by a first bearing housed in the disc-shaped member and the second pivoting pin is pivotally supported by a second bearing housed in the annular member; and
wherein each variable inlet guide vane comprises a trailing portion, integral with the pivoting pin and movable around an axis of the pivoting pin with respect to the disc-shaped member and the annular member; and wherein at least some of the variable inlet guide vanes include a leading portion, which is stationary with respect to the disc-shaped member and the annular member.

2. The device of claim 1, further comprising a plurality of connection members, which rigidly connect the disc-shaped member and the annular member to one another, to form said unit.

3. The device of claim 2, wherein each connection member extends through a respective leading portion of one of said variable inlet guide vanes.

4. The device of claim 1, wherein the disc-shaped member comprises a first side facing the annular member and a second side facing opposite the annular member; and wherein an actuation system for controlling angular displacements of said variable inlet guide vanes is arranged in a seat on the second side of the disc-shaped member.

5. A turbomachine comprising:
a casing;
at least one impeller rotatingly supported in the housing;
an inlet plenum; and
a variable inlet guide vane device according to claim 1, arranged coaxial with the impeller, between the inlet plenum and an inlet of the impeller.

6. The turbomachine of claim 5, said turbomachine being a centrifugal compressor.

7. The turbomachine of claim 5, further comprising a diaphragm stationarily arranged in the casing and coaxial to the impeller; and
wherein the disc-shaped member of is housed in said diaphragm.

8. The turbomachine of claim 7, wherein the annular member is housed in a seat coaxial to the impeller and arranged in a front portion of the casing.

9. A method for assembling variable inlet guide vanes for a turbomachine, the method comprising the following steps:
mounting a set of first bearings in a disc-shaped member; mounting a set of second bearings in an annular member; and
rigidly connecting the disc-shaped member and the annular member to one another with a plurality of variable inlet guide vanes housed therebetween; wherein each variable inlet guide vane comprises a first pin supported for rotation in the first bearing and a second pin supported for rotation in the second bearing; wherein the disc-shaped member, the annular member and the variable inlet guide vanes arranged therebetween form a unit; and wherein each variable inlet guide vane comprises a trailing portion, integral with the pivoting pin and movable around an axis of the pivoting pin with respect to the disc-shaped member and the annular member; and at least some of the variable inlet guide vanes include a leading portion, which is stationary with respect to the disc-shaped member and the annular member.

10. The method of claim 9, further comprising the step of mounting an actuation system for controlling angular displacements of said variable inlet guide vanes in a seat on the second side of the disc-shaped member and connecting each variable inlet guide vane to said actuation system.

11. The method of claim 9, further comprising the step of mounting the unit in a turbomachine.

12. The method of claim 11, wherein the turbomachine is a centrifugal compressor.

13. The method of claim 11, wherein the unit is arranged between a stationary diaphragm of the turbomachine and a front casing portion of the turbomachine.
